(19) United States
(12) Patent Application Publication
(10) Pub. No.: US 2020/0136449 A1
(43) Pub. Date: Apr. 30, 2020

(54) ROTOR ASSEMBLY AND METHOD OF MANUFACTURE THEREOF

(71) Applicant: Dyson Technology Limited, Wiltshire (GB)

(72) Inventor: David George WARNE, Swindon (GB)

(73) Assignee: Dyson Technology Limited, Wiltshire (GB)

(21) Appl. No.: 16/624,864

(22) PCT Filed: Apr. 27, 2018
(86) PCT No.: PCT/GB2018/051131

§ 371 Date: Dec. 19, 2019

(30) Foreign Application Priority Data
Jun. 20, 2017 (GB) 1709834.4

(51) Int. Cl. H02K 1/30; H02K 1/04; H02K 1/27; H02K 7/00; H02K 7/04; H02K 15/03; H02K 15/12

(52) U.S. Cl. CPC H02K 1/30; H02K 1/04; H02K 1/2733; H02K 15/12; H02K 7/04; H02K 15/03; H02K 7/003

(57) ABSTRACT

A method of manufacturing a rotor assembly, the method comprising: providing a magnet in an uncured state comprising a magnetic powder and a binder; providing a shaft onto which the magnet is to be fixed; and assembling an intermediate rotor assembly in which the uncured magnet is positioned on the shaft. The method then comprises heating the intermediate rotor assembly to cure the magnet and to allow a quantity of the binder to leach from the magnet, creating an adhesive bond between the magnet and the shaft.

### CROSS-REFERENCE TO RELATED APPLICATIONS

This application is a national stage application under 35 U.S.C. 371 of International Application No. PCT/GB2018/051131, filed Apr. 27, 2018, which claims the priority of GB Application No. 1709834.4, filed Jun. 20, 2017, the entire content of each of which are incorporated herein by reference.

### FIELD OF THE INVENTION

The present invention relates to a rotor assembly suitable for use in an electrical machine and a method of manufacture thereof.

### BACKGROUND OF THE INVENTION

The rotor of an electrical machine typically comprises a rotor core secured to a shaft. The rotor core may comprise a magnet having a bore through which the shaft is received. Most magnets are relatively brittle and will fracture if subjected to excessive tensile stress. Consequently, rather than press fitting the magnet on to the shaft, the magnet is generally adhered to the shaft.

The magnet may be adhered to the shaft by applying a bead of adhesive to the shaft and then inserting the shaft into the bore of the magnet. During insertion, the shaft may be rotated relative to the magnet so as to achieve a better distribution of adhesive. Nevertheless, as the length of the magnet increases, it becomes increasingly difficult to achieve a continuous distribution of adhesive along the full length of the bore. This in turn results in a weaker join between the magnet and the shaft.

The magnet may alternatively be adhered to the shaft by inserting the shaft into the bore of the magnet and then injecting adhesive into the clearance between the shaft and the magnet. However, it is generally difficult to deliver adhesive along the full length of the bore without trapping pockets of air. This is particularly true when the clearance is relatively small. The net result is a weaker join between the magnet and the shaft.

Accordingly, an improved electric motor is required which goes some way to alleviate the problems discussed above.

This invention provides a method of manufacturing a rotor assembly, the method comprising: providing a magnet in an uncured state comprising a magnetic powder and a binder; providing a shaft onto which the magnet is to be fixed; and assembling an intermediate rotor assembly in which the uncured magnet is positioned on the shaft. The method then comprises heating the intermediate rotor assembly to cure the magnet and to allow a quantity of the binder to leach from the magnet, creating an adhesive bond between the magnet and the shaft.

As a result, a rotor assembly can be manufactured without requiring separate steps for curing the magnet and then applying adhesive to fix the magnet to the shaft. This allows for a quicker and more efficient manufacturing process. In addition, as the binder leaches from the magnet evenly during curing, an even distribution of the binder is used to evenly fix the entire length of the magnet to the shaft. Futhermore, as no separate adhesive is required, the manufactured rotor assembly can be made cheaper. Any motor in which the rotor assembly is subsequently used will also be cheaper.

The shaft may be ceramic, and the surface of the shaft may be textured. Furthermore, one or more grooves may be provided in the surface of the shaft. As a result, the binder that leaches from the magnet during curing can form a stronger bond with the shaft, and an improved rotor assembly is achieved that can spin at faster speeds.

A protective member may be positioned around the uncured magnet prior to curing, and subsequently during the heating step a quantity of the binder may leach from the magnet to create an adhesive bond between the magnet and the protective member. As a result, the magnet is protected, allowing it to spin at even faster speeds, and no additional adhesive was required to fix the protective member to the magnet, resulting in a quicker and more efficient manufacturing process, as well as a cheaper manufactured motor.

The protective member may be a hollow protective sleeve, and the protective sleeve may be formed of a carbon-fibre composite. Alternatively, the protective member may be formed of a pre-impregnated material comprising fibres and a bonding matrix, and may be pre-preg tape.

In the case where the protective member may be formed of a pre-impregnated material comprising fibres and a bonding matrix, during the step of heating the intermediate rotor assembly, a quantity of the bonding matrix may leach from the pre-impregnated material to further strengthen the bond formed between the protective member and the magnet. The amount of binder required to leach from the magnet would also be reduced.

End caps may be provided on the shaft at either end of the magnet, and during the step of heating the intermediate rotor assembly, a quantity of the binder may leach from the magnet, creating an adhesive bond between the magnet and the end caps. By using binder leached from the magnet, no separate adhesive is required, and the manufactured rotor assembly can be made cheaper. In addition, as the end caps can be adhered in the same step as the magnet is cured and fixed to the shaft, the manufacturing process is made more efficient.

The invention further provides a rotor assembly comprising a shaft and a magnet, wherein the magnet is bonded to the shaft only by a binder leached from the magnet during curing of the magnet. As the binder leaches from the magnet evenly during curing, an even distribution of the binder is used to evenly fix the entire length of the magnet to the shaft, resulting in a stronger bond between them. Furthermore, no additional adhesive is required to fix the magnet to shaft, and the rotor assembly can be made cheaper.

A protective member may surround the magnet and the protective sleeve may be bonded to the magnet by the binder that leached from the magnet during curing of the magnet.

The protective sleeve may be formed of a pre-impregnated material and may be further bonded to the magnet by a bonding matrix leached from the pre-impregnated material during curing.

The shaft may be ceramic. In addition, the surface of the shaft may be textured. As a result, a better strength bond can be achieved between the magnet and the shaft, and the rotor assembly is better able to operate at high speeds.

One or more grooves may be provided in the surface of the shaft. Again, this helps to improve the strength of the bond between the magnet and the shaft.

End caps may be provided on the shaft at either end of the magnet, the end caps may be bonded to the magnet by a binder leached from the magnet during curing of the magnet. The end caps help to strengthen the magnet, and also provide a useful barrier to stop too much binder from being lost from the magnet during the curing process.

The end caps may also act as balancing rings for the rotor assembly. Material can be removed from parts of the end caps in order to balance the assembled rotor assembly. As such additional balancing rings are not required, and the rotor assembly can be made more cheaply.

### BRIEF DESCRIPTION OF THE DRAWINGS

In order that the present invention may be more readily understood, embodiments of the invention will now be described, by way of example, with reference to the following accompanying drawings, in which:

FIG. 1 is an exploded view of a rotor assembly;

FIG. 2 is a cross section through a rotor assembly;

FIG. 3 is a flow diagram outlining the method of assembling a rotor assembly;

FIGS. 4a, 4b and 4c show steps in a method of assembling a rotor assembly;

FIGS. 5a and 5b show a close up view of part of FIGS. 4b and 4c; and

FIGS. 6a, 6b, 6c, and 6d each show a shaft having a feature for improving adhesive bonds with the shaft.

### DETAILED DESCRIPTION OF THE INVENTION

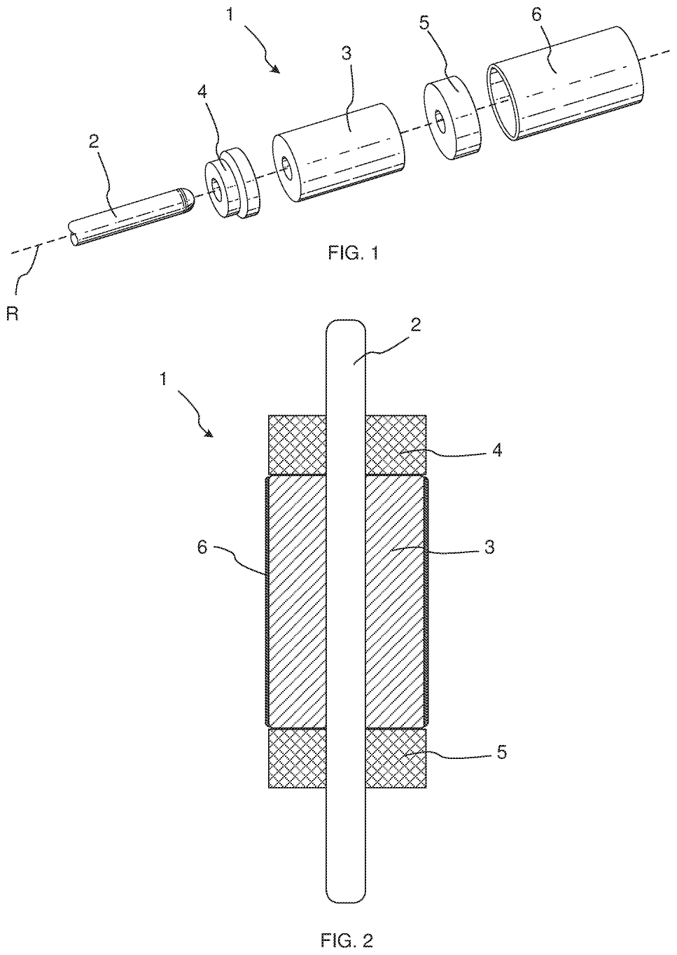

FIG. 1 shows a rotor assembly 1, and FIG. 2 shows a cross section through a schematic representation of the rotor assembly 1. The rotor assembly comprises a shaft 2 and a magnet 3. The shaft 2 is ceramic, however other materials may be used for the shaft, for example a metal such as steel. The magnet 3 is a permanent magnet. The magnet is formed of a magnetic powder and a binder. The binder is an epoxy. Typically permanent magnets of this sort are formed by compressing the magnetic powder and the binder together and then heating or baking the magnet to cure the binder.

The rotor assembly further comprises end caps 4 and 5 which are positioned either side of the magnet along the rotational axis R of the rotor assembly. FIG. 1 also shows a protective member in the form of a protective sleeve 6. The protective sleeve 6 is a hollow cylindrical body formed of carbon-fibre composite. Alternative protective members may be used, for example the protective member could be a pre-impregnated material that is wrapped around the magnet such as pre-preg tape. Pre-preg tape is a material formed of fibres that are pre-impregnated with a bonding matrix. If the magnet 3 is structurally sound on its own then a protective member may not be necessary.

It is usual to fix a magnet to a shaft once the magnet has already been cured, and an adhesive is used to bond the cured magnet to the shaft. However, the rotor assembly 1 of FIGS. 1 and 2 does not require additional adhesive. Instead, the magnet 3 of the rotor assembly 1 is fixed to the shaft 2 by the binder that is used to bind the magnet together. During curing of the magnet, a small amount of the epoxy naturally leaches from the body of the magnet. This small amount of leached binder flows from the body of the magnet and fills the gap between the shaft 2 and the magnet 3, forming an adhesive bond between the two parts.

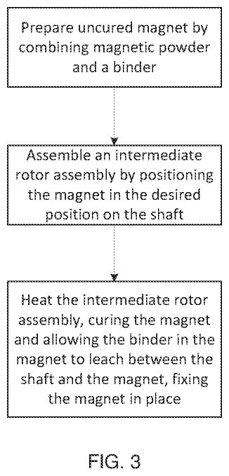

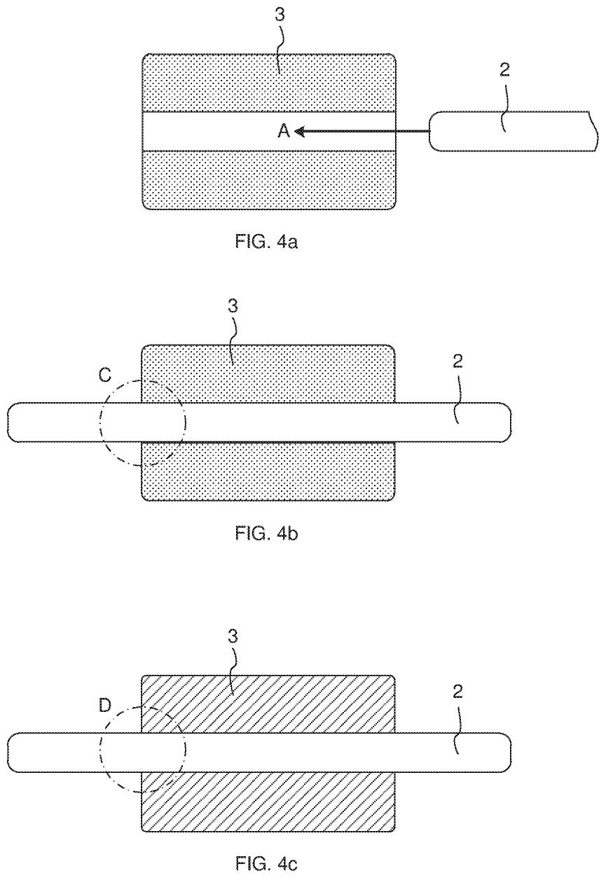

FIG. 3 is a flow diagram which outlines the steps of a method for assembling a rotor assembly, and FIGS. 4a, 4b, and 4c show the parts at different stages on the steps described in the method of FIG. 3. A permanent magnet such as the magnet 3 described above is prepared in the usual way by combining magnetic powder with a binder, such as an epoxy. The powder and binder is compressed together to form the shape of the magnet body. However, the magnetic powder and binder are not yet cured. Instead, the magnet remains uncured. An uncured magnet such as this is sometimes referred to as being in a “green-state”. The uncured magnet comprises a bore.

An intermediate rotor assembly is assembled by positioning the uncured magnet 3 in a desired position on the shaft 2. This is done by sliding a shaft 2 through the bore of the magnet 3 until the desired position is achieved, as shown in FIG. 4a represented by arrow A. In this example, the uncured magnet has been pre-compressed to form the shape of the magnet prior to positioning the uncured magnet on the shaft. However, an alternative is that the magnetic powder and binder of the uncured magnet could be compressed around the shaft in the desired position.

Once the magnet 3 is in the correct position on the shaft 2, as shown in FIG. 4b, the intermediate rotor assembly is heated. The heat cures the magnet 3, and the magnetic powder is fixed inside the cured binder. During curing, some natural leaching of the binder occurs. The binder which leaches from the body of the magnet 3 fills the space between the magnet 3 and the shaft 2, and forms an adhesive bond between them. Accordingly no additional adhesive is required to fix the magnet 3 to that shaft 2. FIG. 4c shows the cured magnet 3 fixed to the shaft 2.

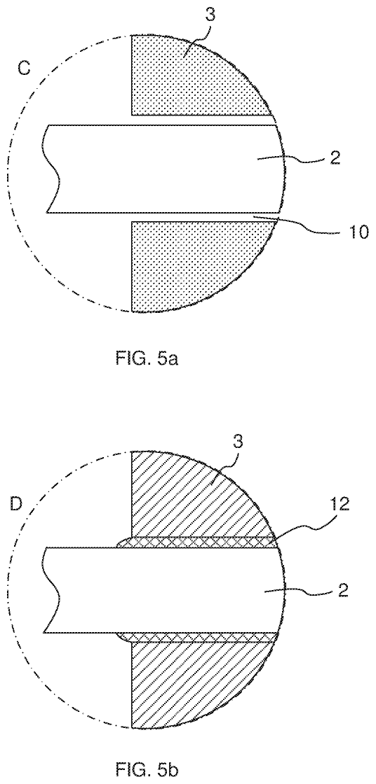

The leaching of the binder is shown in more detail in FIGS. 5a and 5b, which show magnified sections C and D from FIGS. 4b and 4c. Before the magnet 3 is cured, a space 10 may exist between the uncured magnet 3 and the shaft 2. In order to be able to place the uncured magnet 3 over the shaft in the correct position, the diameter of the bore formed in the magnet 3 is slightly bigger than the shaft 2. In the alternative situation where the powder is compressed onto the shaft, such a pronounced gap may not exist.

During heating of the intermediate rotor assembly, as has already been explained, some binder leaches out of the magnet 3. As shown in FIG. 5c, the leached binder 12 fills the gap between the magnet 3 and the shaft 2 and forms an adhesive bond between the two.

If end caps are required on the rotor assembly, the method simply includes the additional step of positioning the end caps in place around the uncured magnet 3. The end caps may form an interference fit with the shaft 2. During curing of the magnet 3, binder leaches from the magnet 3 and fills the gap between the magnet 3 and the end caps, and forms an adhesive bond between them. An alternative to having an interference fit between the end caps and the shaft 2 is to ensure that enough binder is able to leach from the magnet body during curing to flow along the shaft 2 and also provide an adhesive bond between the end caps and the shaft 2. However, as only a small amount of binder typically leaches from the magnet 3, it may be necessary to include additional binder material in the uncured magnet.

A similar process is carried out if the rotor assembly requires a protective member such as a protective sleeve. Binder from the magnet 3 will leach out during curing of the magnet 3 and form an adhesive bond between the protective sleeve and the magnet 3. In the case where a pre-impregnated material is used as a protective member, the bonding matrix used to pre-impregnate the material may also leach and help strengthen the bond between the magnet and the protective member.

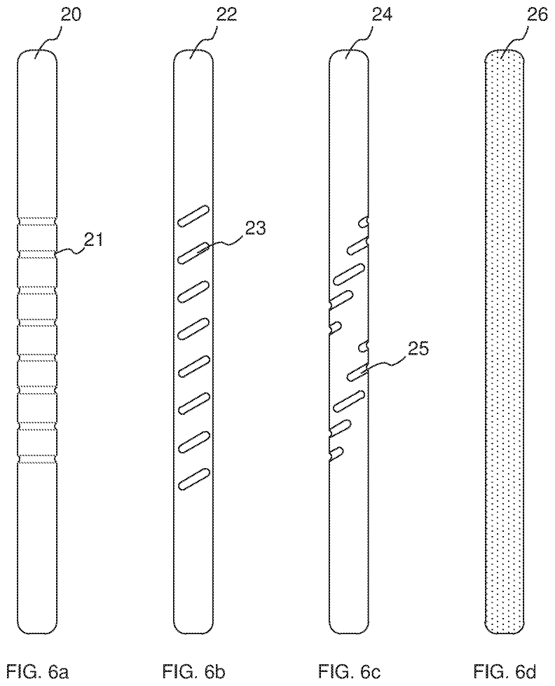

Whilst the bond formed between the shaft 2 and the magnet 3 is strong, an even stronger bond can be achieved by providing the shaft with features that allow the adhesive to adhere better to the shaft surface. FIGS. 6a, 6b, 6c and 6d all show examples of shafts having features such as these. In FIG. 6a, shaft 20 has a number of annular grooves 21 formed around part of the circumference of the shaft to which a magnet is to be fixed. In FIG. 6b, shaft 22 has a number of angled indentations positioned linearly down the length of the shaft 22 where the magnet is to be fixed. In FIG. 6c, similar angled indentations 25 to those shown in FIG. 6b are formed in the surface of the shaft 24. However, instead of being positioned linearly, they are positioned in a helical pattern along the length of the shaft 24 where a magnet is to be fixed.

The shaft 26 in FIG. 6d has a textured surface. A textured surface may be particularly beneficial is it provides an evenly strengthened bond across the entire surface of the shaft. In addition, indentations and grooves, such as those shown in FIGS. 6a, 6b and 6c could have a detrimental effect on the strength of the shaft itself. But by texturing the surface of the shaft, the structural integrity of the shaft is maintained at a high level, and the strength of the adhesive bond is also improved.

Whilst particular embodiments have thus far been described, it will be understood that various modifications may be made without departing from the scope of the invention as defined by the claims.

1. A method of manufacturing a rotor assembly, the method comprising:
providing a magnet in an uncured state comprising a magnetic powder and a binder;
providing a shaft onto which the magnet is to be fixed; and
assembling an intermediate rotor assembly in which the uncured magnet is positioned on the shaft;
heating the intermediate rotor assembly to cure the magnet and to allow a quantity of the binder to leach from the magnet, creating an adhesive bond between the magnet and the shaft.

2. The method of manufacturing a rotor assembly of claim 1, wherein the shaft is ceramic.

3. The method of manufacturing a rotor assembly of claim 1, wherein the surface of the shaft is textured.

4. The method of manufacturing a rotor assembly of claim 1, wherein one or more grooves are provided in the surface of the shaft.

5. The method of manufacturing a rotor assembly of claim 1, wherein a protective member is positioned around the uncured magnet prior to curing, and wherein during the heating step a quantity of the binder leaches from the magnet to create an adhesive bond between the magnet and the protective member.

6. The method of manufacturing a rotor assembly of claim 5, wherein the protective member is a hollow protective sleeve.

7. The method of manufacturing a rotor assembly of claim 6, wherein the protective sleeve is formed of a carbon-fiber composite.

8. The method of manufacturing a rotor assembly of claim 5, wherein the protective member is formed of a pre-impregnated material comprising fiber and a bonding matrix.

9. The method of manufacturing a rotor assembly of claim 8, wherein the pre-impregnated material is pre-preg tape.

10. The method of manufacturing a rotor assembly of claim 8, wherein during the step of heating the intermediate rotor assembly, a quantity of the bonding matrix leaches from the pre-impregnated material to further strengthen the bond formed between the protective member and the magnet.

11. The method of manufacturing a rotor assembly of claim 1, wherein end caps are provided on the shaft at either end of the magnet.

12. The method of manufacturing a rotor assembly of claim 11, wherein during the step of heating the intermediate rotor assembly, a quantity of the binder leaches from the magnet, creating an adhesive bond between the magnet and the end caps.

13. A rotor assembly comprising a shaft and a magnet, wherein the magnet is bonded to the shaft only by a binder leached from the magnet during curing of the magnet.

14. The rotor assembly of claim 13, further comprising a protective member surrounding the magnet and the protective sleeve is bonded to the magnet by the binder that leached from the magnet during curing of the magnet.

15. The rotor assembly of claim 14, wherein the protective sleeve is formed of a pre-impregnated material and is further bonded to the magnet by a bonding matrix leached from the pre-impregnated material during curing.

16. The rotor assembly of claim 13, wherein the shaft is ceramic.

17. The rotor assembly of claim 13, wherein the surface of the shaft is textured.

18. The rotor assembly of claim 13, wherein one or more grooves are provided in the surface of the shaft.

19. The rotor assembly of claim 13, wherein end caps are provided on the shaft at either end of the magnet, the end caps being bonded to the magnet by a binder leached from the magnet during curing of the magnet.

20. The rotor assembly of claim 19, wherein the end caps also act as balancing rings for the rotor assembly.
